(19) United States
(12) Patent Application Publication
(10) Pub. No.: US 2026/0226967 A1
(43) Pub. Date: Aug. 6, 2026

(54) HYDRAULIC MACHINE

(71) Applicant: DANFOSS SCOTLAND LIMITED, Edinburgh (GB)

(72) Inventors: Christian NORGAARD, Edinburgh (GB); Niall CALDWELL, Edinburgh (GB); Andrew HANSEN, Ames, IA (US); Daniil DUMNOV, Edinburgh (GB); Uwe Bernhard Pascal STEIN, Edinburgh (GB)

(21) Appl. No.: 19/149,462

(22) PCT Filed: Jan. 19, 2024
(86) PCT No.: PCT/EP2024/051322

§ 371 Date: Jul. 18, 2025

(30) Foreign Application Priority Data
Jan. 20, 2023 (EP) 23152781.3

(51) Int. Cl. F16H 39/20

(52) U.S. Cl. CPC F16H 39/20

(57) ABSTRACT

A hydraulic machine assembly (8), comprises: a first hydraulic machine (10) comprising a first set of machine modules (56) arranged around a first machine shaft (12), each machine module (56) of the first set comprising a group of fluidly-coupled piston assemblies (18) in driving engagement with a first set of cams (16) carried by the first machine shaft (12); and a second hydraulic machine (10) comprising a second set of machine modules (56) arranged around a second machine shaft (12), each machine module (56) of the second set comprising a group of fluidly-coupled piston assemblies (18) in driving engagement with a second set of cams (16) carried by the second machine shaft (12). Rotation of the second machine shaft (12) is coupled to rotation of the first machine shaft (12). The first set of cams (16) are angularly offset relative to the second set of cams (16), and respective angular orientations of the cams (16) of the first set of cams (16) are interleaved with respective angular orientations of the cams (16) of the second set of cams (16). The phase of each piston assembly (18) is unique, so that all of the piston assemblies (18) of the machine assembly (8) are out-of-phase, the respective phases of the piston assemblies (18) of the machine assembly (8) being evenly spaced.

### FIELD OF THE INVENTION

The invention relates to hydraulic machines, and in particular to electronically commutated hydraulic machines.

### BACKGROUND TO THE INVENTION

Hydraulic systems often include several actuators and other consumers that have varying demands. For example, a hydraulic system of an excavator may have one or more hydraulic circuits, each including a set of actuators that are operable to effect the various actions that the excavator must perform. Hydraulic fluid is directed to each of those actuators at different times, according to the present activity of the excavator and commands of the operator.

In such systems, it is desirable to create flexibility of operation whilst optimising utilisation of equipment and resources, taking account also of space constraints within the excavator or other host machine for accommodating the components of the hydraulic system.

One approach to delivering this flexibility is to use an electronically commutated hydraulic machine (ECM) such as an electronically commutated pump (ECP), also referred to as a ‘digital displacement pump’. An ECM can be driven by a single prime mover while providing a set of independently-operable machine modules, which in the case of an ECP are pump modules that each provide a respective independently-variable displacement, similar to a number of individual pumps. Each pump module is associated with a group of piston cylinder units (PCUs) that are fluidly coupled, or ‘ganged’, in that the outputs of the PCUs of the group are combined to define the output of the pump module. The PCUs can then be operated or deactivated individually to regulate the output of the associated pump module.

The sinusoidal operation of the PCUs creates a pulse or ripple effect in the corresponding pump module output, although this can be mitigated by spreading the phases of the PCUs within the pump module. For example, each PCU of a pump module may be driven by a different cam, with the respective eccentricities of the cams being mutually offset to provide the desired spacing between the phases of the PCUs.

Similarly to ganging PCUs, pump modules may be ganged using suitable connections and valve arrangements. Such ganging may be selective, to enable the pump module outputs to be combined to meet a demand for peak flow at certain times and then separated at other times to perform other functions. This takes account of the fact that excavators and similar machines seldom require peak pressure or flow to multiple actuators simultaneously, and in that context the ganging enhances the peak flow that can be delivered without increasing the capacities of the individual PCUs and therefore the space consumed by the ECP.

Flexibility of operation may be extended by adding a further ECP to provide additional independently-operable pump modules and thereby enhance the functionality of the system, albeit at the cost of the additional space required to accommodate the second ECP. As for systems using a single ECP, it is also possible for the pump modules of multiple ECPs to be ganged to provide desired functionality.

It is against this background that the present invention has been devised.

### SUMMARY OF THE INVENTION

An aspect of the invention provides a hydraulic machine assembly. The assembly comprises: a first hydraulic machine comprising a first set of machine modules arranged around a first machine shaft, each machine module of the first set comprising a group of fluidly-coupled piston assemblies in driving engagement with a first set of cams carried by the first machine shaft; and a second hydraulic machine comprising a second set of machine modules arranged around a second machine shaft, each machine module of the second set comprising a group of fluidly-coupled piston assemblies in driving engagement with a second set of cams carried by the second machine shaft. Rotation of the second machine shaft is coupled to rotation of the first machine shaft.

The piston assemblies of each machine module of the first set may be out-of-phase with the piston assemblies of an adjacent machine module of the second set.

The first set of cams may be angularly offset relative to the second set of cams. The respective angular orientations of the cams of the first set of cams may be interleaved with the respective angular orientations of the cams of the second set of cams. The angular orientation of each cam may be defined with respect to an axis of the associated machine shaft, for example. The first set of cams may be angularly offset from one another around the first machine shaft, and the second set of cams may be angularly offset from one another around the second machine shaft. Offsetting of the first and second sets of cams may be achieved by a mutual offset between the first and second machine shafts, for example. The angular orientation of each cam may also be expressed as a phase of the cam, and so the first and second sets of cams may be offset in phase, and the phases of the first and second sets of cams may be interleaved. In addition, the first set of cams may be out-of-phase with one another, and similarly the second set of cams may be out-of-phase with one another.

The cams may be eccentric cams, for example, which may also be referred to as ‘eccentrics’. Alternatively, or in addition, the cams may have lobes.

The phase of each piston assembly may be unique, in that each piston assembly has a different phase, so that all of the piston assemblies of the machine assembly may be out-of-phase. The respective phases of the piston assemblies of the machine assembly may be evenly spaced so that the piston assemblies are equiphased. This arrangement may allow any two or more machine modules of the assembly to be connected fluidly to produce a steadier combined output, for example, or collectively to draw a steadier input, relative to arrangements in which piston assembly phases are not evenly spaced.

The phase of a piston assembly may comprise or be defined by a phase or stage of a working cycle of the piston assembly. This, in turn, may be determined by a geometric relationship between the piston assembly and a cam that the assembly is engaged with, and an angular position of the piston assembly within the hydraulic machine with respect to the associated machine shaft. The working cycle of the piston assembly may refer to a full cycle of reciprocating movement of a piston of the piston assembly, for example completion of an intake stroke and an outlet stroke. It follows that the phase of the working cycle of each piston assembly may be unique, so that the working cycles of all of the piston assemblies of the machine assembly may be out-of-phase, and that the respective phases of the working cycles of the piston assemblies of the machine assembly may be evenly spaced.

A machine module may be configured as a pump module or as a motor module, for example.

For a given machine module of the first set, the ‘adjacent’ machine module of the second set is the machine module of the second set that is closest to the machine module of the first set. Depending on how the machines are arranged relative to one another, adjacent machine modules may be circumferentially or axially aligned with respect to an axis of the first and/or second machine shaft, for example.

The respective phases of the piston assemblies of adjacent machine modules of the first and second machines may be evenly spaced, so that the piston assemblies of the adjacent machine modules are equiphased.

In some embodiments, the piston assemblies of the machine modules of the first and second machines are arranged in axially-spaced rows, the piston assemblies of each row being arranged around, and in driving engagement with, a respective cam of the associated machine shaft. Each row of piston assemblies may contain an equal number of piston assemblies. For each machine, the number of rows of piston assemblies may be coprime with the number of piston assemblies in each row. In such embodiments, the total number of rows of piston assemblies of the machine assembly may be coprime with the number of piston assemblies in each row. Each machine module may comprise at least one piston assembly from each row of the associated machine. For each machine module, each piston assembly of the machine module may be in a respective row. For each row of piston assemblies, each piston assembly of the row may belong to a different machine module of the associated machine. In some embodiments, each row of piston assemblies contains an odd number of piston assemblies.

For each machine module, each piston assembly of the machine module may be in driving engagement with a different cam of the associated set of cams.

The respective phases of the cams of the first and second sets may be equispaced.

Each machine module of the first machine is optionally fluidly connected or connectable to the corresponding adjacent machine module of the second machine. If the piston assemblies of adjacent machine modules are out-of-phase, the combined output from, or input to, the modules, when connected, exhibits low ripple and is therefore steadier than for arrangements in which connected piston assemblies operate in-phase.

The assembly may comprise a module connector configured to connect the machine modules of the first and second machines fluidly. In such embodiments, optionally each machine module may connect to the module connector through a respective passage extending parallel to the associated machine shaft, in which case the respective passages of adjacent machine modules of the first and second machines may be mutually coaxial.

The module connector may be disposed between the first and second machines.

The module connector may be configured or operable to connect any two or more machine modules of the assembly fluidly. The module connector may be configured or operable to connect adjacent machine modules of the first and second machines fluidly. The module connector may comprise a valve arrangement that is operable to fluidly connect or disconnect machine modules selectively.

The module connector may be embodied as, or may be defined by part of, a ganging block, or ganging assembly. A ganging block may in turn be composed of separate parts, such as an intermediate ganging block and a top ganging block, and optionally the module connector may be defined by one or more of those parts.

Each machine module may comprise, or fluidly connect to, a respective passage extending parallel to the associated machine shaft. The passage may define a high pressure gallery into which the piston assemblies of the machine module displace fluid, for example, or from which the piston assemblies receive fluid. The passage may be embodied as a drilling in a housing of the machine. The respective passages of adjacent machine modules of the first and second sets may be mutually coaxial.

Adjacent machine modules of the first and second machines may be circumferentially aligned with respect to the first and second machine shafts.

The first machine shaft may be coaxial with the second machine shaft, for example if the first and second machines are arranged end-to-end. The first machine may have a reverse orientation to the second machine. For example, the machines may be arranged back-to-back, or front-to-front. Alternatively, the first and second machines may have similar orientations and may thus be arranged back-to-front.

Alternatively, the first and second machines may be arranged side-by-side, so that the first and second machine shafts are mutually parallel. The first and second machine shafts may both couple to a common gearbox, such as a splitter gearbox. In such embodiments, adjacent machine modules of the first and second machines may be axially aligned.

The first and second machines may be substantially identical, although the first and second machine shafts may nonetheless be mutually offset in such embodiments, to provide for phasing of the piston assemblies. Accordingly, in such embodiments it is possible for the machine shafts to be different to one another, or at least assembled within their respective machines at different orientations, while the machines are otherwise substantially identical.

The first and second machines may each comprise a respective machine housing. Alternatively, the first and second machines may share a common housing.

The first machine and/or the second machine may be electronically-commutated. For example, the first and second machines may define electronically-commutated pumps or electronically-commutated motors.

Each machine module may be configured as a pump module in which the respective outputs of the associated piston assemblies are combined. Alternatively, the machine modules may be configured as motor modules. For each module, the piston assemblies of the module may draw fluid from a common input.

For each machine module, the respective phases of the piston assemblies of the machine module may be evenly spaced.

Each piston assembly may comprise a high-pressure port. Each piston assembly may include a high-pressure valve for controlling flow through the high-pressure port, for example into or out from a working chamber of the piston assembly. Each piston assembly may comprise an actuator for opening and/or closing the high-pressure valve. The actuator may be operable to open and/or close the high-pressure valve selectively, and at a variable stage of the working cycle of the piston assembly, to regulate the volume of high-pressure fluid admitted to a working chamber of the piston assembly on each working cycle of the piston assembly.

Each piston assembly may include a low-pressure port. Each piston assembly may comprise a low-pressure valve for controlling flow through the low-pressure port, for example into or out from a working chamber of the piston assembly. Each piston assembly may comprise an actuator for opening and/or closing the low-pressure valve. The actuator may be operable to open and/or close the low-pressure valve selectively, and at a variable stage of the working cycle of the piston assembly, to regulate the volume of fluid admitted to and/or pressurised within a working chamber of the piston assembly on each working cycle of the piston assembly.

In embodiments in which, for each piston assembly, the volume of fluid admitted to and/or pressurised in a working chamber of the piston assembly on each working cycle can be regulated, each piston assembly may be configured for partial and/or idle working cycles, meaning working cycles in which a reduced quantity of fluid, and potentially substantially no working fluid, passes through the high pressure port and high pressure valve. For the example of a pump, a partial cycle is one in which a reduced quantity of fluid is displaced by the piston assembly via the high pressure port and high pressure valve, and the remaining displacement in said partial cycle by the piston assembly passes via the low pressure port and low pressure valve.

Each machine module may be independently operable, which may mean that the output from and/or input to the machine module can be controlled and varied independently of other machine modules, for example through appropriate control of actuators and valves of the machine module. Each piston assembly may be independently operable, which may mean that the output from and/or input to the piston assembly can be controlled and varied independently of other piston assemblies, for example through appropriate control of actuators and valves of the piston assembly. A group of independently operable piston assemblies may form an independently operable machine module.

The invention also extends to a hydraulic system comprising the hydraulic machine assembly of the above aspect.

Another aspect of the invention provides a method of operating the assembly or the system of the above aspects. The method comprises allocating two or more machine modules to a first group and one or more machine modules to a second group, and controlling each of the first and second groups independently to deliver respective outputs, which may be different to each other, so that the combined output of the first and second groups meets a demand.

The first group may comprise a machine module of the first set and an adjacent machine module of the second set. The method may comprise modulating the output of the first group in preference to the second group to meet a change in demand.

It will be appreciated that preferred and/or optional features of each aspect of the invention may be incorporated alone or in appropriate combination in the other aspects of the invention also.

### BRIEF DESCRIPTION OF THE DRAWINGS

In order that the invention may be more readily understood, preferred non-limiting embodiments thereof will now be described, by way of example only, with reference to the accompanying drawings, in which like features are assigned like reference numerals, and in which:

FIG. 1 shows a hydraulic machine assembly according to an embodiment of the invention in plan view;

FIG. 2 shows an end view of the assembly of FIG. 1;

FIG. 3 shows a cross section taken through the line A-A in FIG. 1;

FIG. 4 shows a PCU of the assembly of FIG. 1 schematically;

FIG. 5 shows a partial cross section taken through the line B-B in FIG. 1; and

FIG. 6 corresponds to FIG. 5 but shows a variant of a ganging block of the assembly of FIG. 1.

### DETAILED DESCRIPTION OF EMBODIMENTS OF THE INVENTION

In general terms, embodiments of the invention provide hydraulic machine assemblies comprising multiple hydraulic machines that are configured for improved performance when machine modules of the machines are fluidly coupled, or ‘ganged’. In the embodiment described below the machines are ECMs, and more specifically ECPs, and so the machine modules are pump modules. It should be appreciated that the principles of the invention apply equally to machines configured to operate as motors, in which case the machine modules may be motor modules. The assembly of the below example includes two ECPs and so forms a double machine, although in principle assemblies may include more than two machines.

In some embodiments, the PCUs of modules of an assembly that may be ganged are configured to be out-of-phase with one another, and optionally the phases are equispaced so that the PCUs are equiphased, in that the phases are evenly distributed at regular angular intervals. This beneficially reduces ripple in the combined output of the ganged modules by spacing the pulses in the output evenly. The ‘phase’ of a PCU refers to the stage of its working cycle, which in practice may correspond to a position and direction of movement of a piston of the PCU, for example with reference to top-dead-centre (TDC) and bottom-dead-centre (BDC) positions of the piston, which may be expressed as an angle.

In the example described below, each pump module comprises three PCUs forming a triplet, and so it follows that combining two pump modules creates a hexlet, although it is noted that pump modules may include any number of PCUs. The phases of the PCUs of the hexlet are at regular 60° intervals and are thus equispaced, such that the hexlet is equiphased.

It is noted that a hexlet could be referred to as a ‘pump module’, although for the purposes of this description a pump module is a group of PCUs from one machine.

Equiphasing the hexlet beneficially reduces ripple in the output of the hexlet to an even greater degree than the outputs of the individual triplets. In this respect, embodiments of the invention are therefore partly predicated on the insight that combining the outputs of two different machines creates an opportunity to reduce ripple in the pressure and/or flow of fluid displaced by the machines.

The assembly of the below embodiment is also configured such that all PCUs of the entire assembly are out-of-phase with one another, so that no two PCUs have the same phase. Indeed, the PCUs of the overall assembly are equiphased in the below embodiment. This means that ganging any two pump modules of the assembly results in a relatively smooth output. Moreover, all of the pump modules of the assembly may be ganged together, for example to meet a demand for peak output, in which case the output will be particularly smooth due to the equiphasing of the PCUs across the assembly.

The equiphasing of the PCUs can be provided for in various ways, as shall become clear from the description that follows.

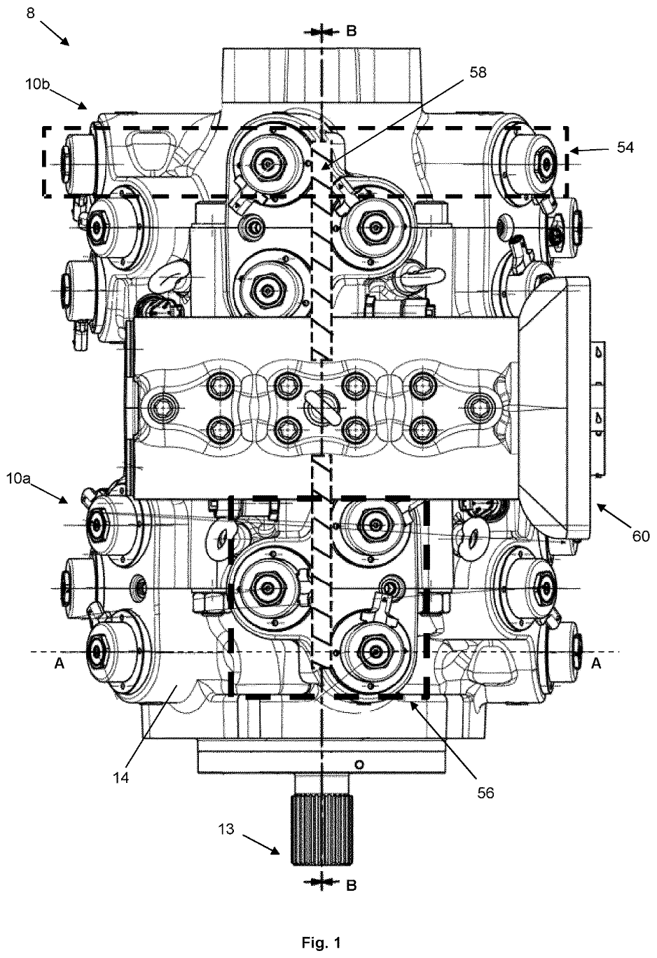

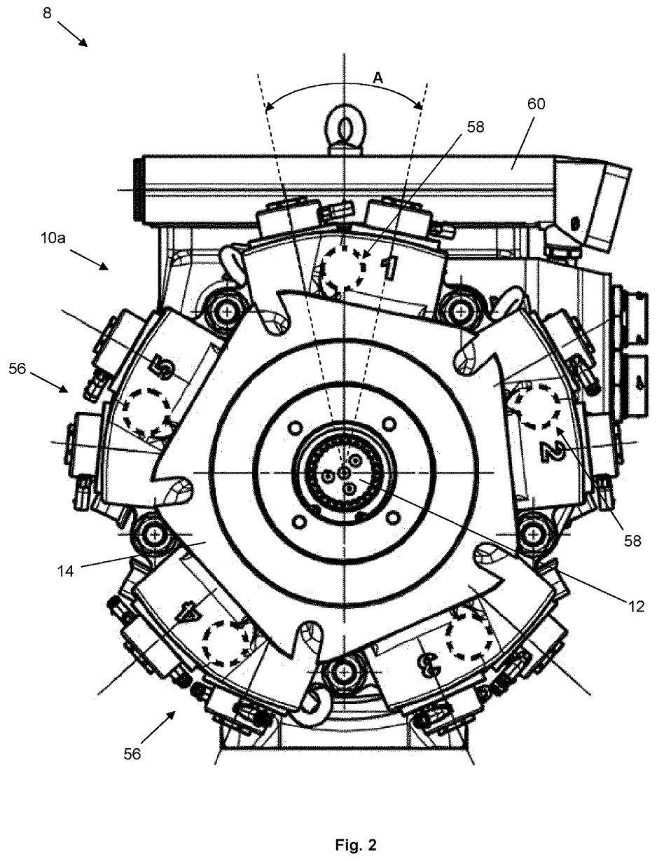

In this respect, FIGS. 1 and 2 show top and end views respectively of a hydraulic machine assembly 8 according to an embodiment of the invention. The assembly 8 comprises two individual ECMs, specifically ECPs 10, that are coupled together both fluidly and mechanically to form the assembly 8, which therefore defines a double machine. In the orientation shown in FIG. 1, the lowermost ECP defines a first ECP 10a and the uppermost ECP defines a second ECP 10b.

The ECPs 10 are substantially identical to one another in this example and are arranged back-to-back, in that the ECPs 10 are coupled with mutually reverse orientations.

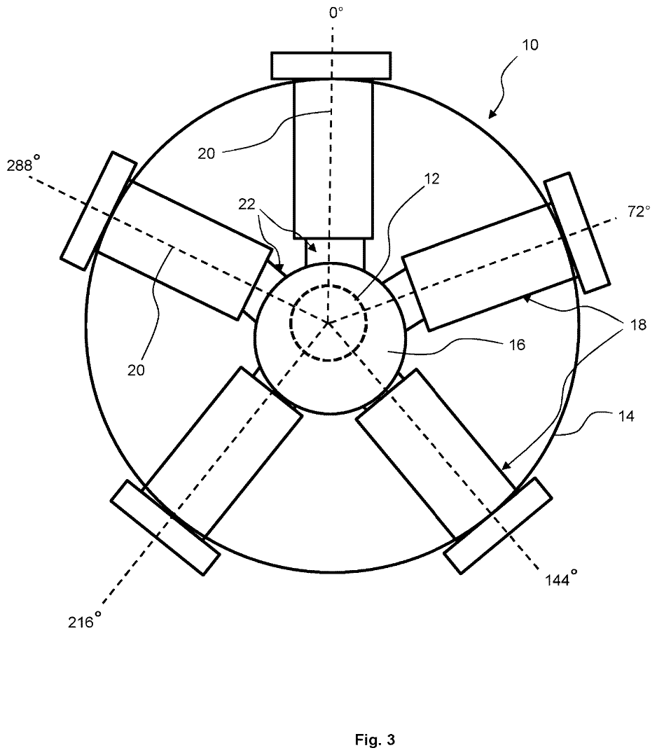

Before considering the configuration of the double machine in more detail, the configuration of the individual ECPs 10 shall first be described. In this respect, FIG. 3 shows a transverse cross section taken through the first ECP 10a, specifically through the line A-A in FIG. 1. This reveals that the first ECP 10a includes a machine shaft defining a first driveshaft 12, which is driven by a prime mover (not shown) such as an internal combustion engine or an electric motor, for example. The driveshaft 12 couples to the prime mover via an axially protruding end portion 13 of the driveshaft 12, which is visible at the bottom of the assembly 8 in FIG. 1. The end portion 13 is enlarged and splined to facilitate coupling to the prime mover in this example.

Although not shown in the figures, the second ECP 10b comprises a second driveshaft that is coaxial with and coupled to, and therefore driven by, the first driveshaft 12, such that rotation of the first driveshaft 12 is coupled to rotation of the second driveshaft. Coupling between the driveshafts may be effected in any suitable way, for example using a splined male-female interface or mechanical fixings. Providing a respective driveshaft 12 for each ECP 10, as in this embodiment, eases assembly of the ECPs 10 by allowing each driveshaft 12 to be aligned with its associated PCUs in each ECP 10, before coupling the ECPs 10 and their associated driveshafts 12 together. As described in more detail below, the first and second driveshafts are mutually offset, which contributes to the creation of equiphased PCUs.

The first driveshaft 12 is housed within a crankcase that defines a housing 14 of the ECP 10, the housing 14 having a circular cross-section in FIG. 3. The first driveshaft 12 has a central axis defining a shaft axis that is common to the first and second driveshafts, and which is aligned with the centre of the housing 14 in this example.

The first driveshaft 12 carries a set of three eccentric cams 16, which may also be referred to as ‘eccentrics’, arranged in axial series along the first driveshaft 12, one of which cams is visible in FIG. 3, which may be fixed to or integral with the driveshaft 12. The respective eccentricities of the second and third cams, which are not visible in FIG. 3, are arranged such that the three cams 16 are mutually offset circumferentially and so have different angular orientations with respect to an axis of the first driveshaft 12, as explained further later. In this example, the angular orientation of a cam 16 may be defined by its eccentricity. In other examples the cams may have radially protruding lobes, in which case an angular orientation of a cam may be defined by a position of a lobe of the cam, for example. The angular orientation of a cam 16 may also be expressed as a ‘phase’ of the cam. Correspondingly, the second driveshaft carries a similar set of eccentric cams.

In the simplified example shown in FIG. 3, a set of five identical PCUs 18 are arranged in a circular array around the cam 16 that is visible. The five PCUs 18 visible in FIG. 3 form an axially-aligned group defining a row or bank 54 of PCUs 18, one of which banks 54 is indicated by an oblong dashed box in FIG. 1. FIG. 1 also makes clear that each ECP 10 comprises three such banks 54 of PCUs 18, the banks 54 of each ECP 10 being axially-spaced at regular intervals so that the PCUs 18 of each bank 54 engage a respective one of the cams 16 of the associated driveshaft 12.

Returning to FIG. 3, each PCU 18 has a longitudinal axis defining a cylinder axis 20 that extends radially within the housing 14, the respective cylinder axes 20 of the PCUs 18 of the bank extending in a common plane that is orthogonal to the shaft axis. The PCUs 18 are equi-angularly spaced around the driveshaft 12, and hence their respective cylinder axes 20 are spaced at 72° intervals around the shaft axis. For illustrative purposes, the uppermost PCU 18 shown in FIG. 3 aligns with the vertical and so is designated as 0° for illustrative purposes, although FIG. 2 shows that the ECP 10 is actually oriented slightly differently.

Each PCU 18 comprises a piston slipper 22 that engages a tubular outer face of the cam 16 to form a running interface with the cam 16 and therefore act as a cam follower. As is conventional, as the driveshaft 12 rotates in operation the eccentricity of the cam 16 causes the cam 16 to drive the PCUs 18 in angular succession, via their respective piston slippers 22.

As the PCUs 18 are equiangularly spaced around the cam 16, it follows that the states of the PCUs 18 of each bank 54, corresponding to the radial positions of the respective piston slippers 22, are equiphased with respect to one another.

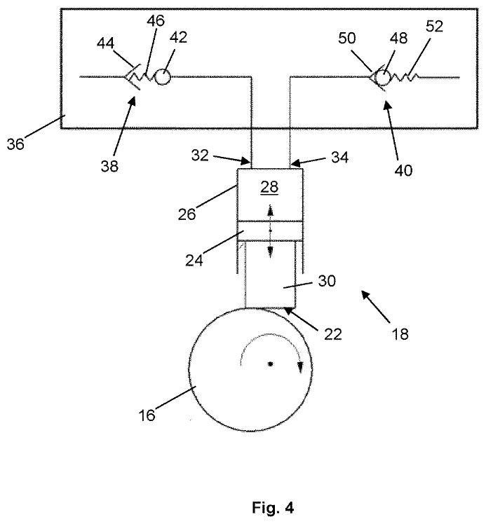

FIG. 4 shows an individual PCU 18 in more detail. This reveals that the PCU 18 comprises a piston 24 received within a cylinder 26, defining a working chamber 28 therebetween. On an opposite side of the piston 24 to the working chamber 28, a piston rod 30 extends towards the cam 16, a distal end of the piston rod 30 carrying or defining the piston slipper 22 that engages the cam 16. Reciprocating movement of the piston slipper 22 as the cam 16 rotates during pumping drives corresponding linear reciprocating movement of the piston 24 relative to and within the cylinder 26, causing pressurisation of hydraulic fluid in the working chamber 28.

The working chamber 28 comprises two fluid ports, namely a low-pressure port 32 and a high-pressure port 34. Hydraulic fluid is drawn into the working chamber 28 through the low-pressure port 32 at relatively low pressure, for example from a low-pressure manifold. The hydraulic fluid is then pressurised and discharged from the working chamber 28 at elevated pressure through the high-pressure port 34 into a high-pressure manifold that is described later. When the respective PCU 18 is operating in a pumping mode, the low-pressure port 32 therefore defines an inlet of the PCU 18 and the high-pressure port 34 defines an outlet of the PCU 18.

Flow of hydraulic fluid through each of the ports 32, 34 is governed by a respective valve of a valve arrangement 36. Accordingly, the valve arrangement 36 includes a low-pressure valve (LPV) 38 that acts to open and close the low-pressure port 32, and a high-pressure valve (HPV) 40 that acts to open and close the high-pressure port 34. Accordingly, the LPV 38 opens while the piston 24 undergoes a filling or intake stroke, corresponding to downward movement in FIG. 4, and closes as the piston 24 undergoes a pumping stroke to displace the hydraulic fluid at elevated pressure, corresponding to upward movement in FIG. 4. Conversely, the HPV 40 operates in a complementary manner and so opens during the pumping stroke to permit the pressurised fluid to be discharged, and closes during the intake stroke.

Completion of both an intake stroke and an outlet stroke by the piston 24 defines one working cycle of the PCU 18. For the case of a pump, the outlet stroke corresponds to a pumping stroke.

The LPV 38 is shown schematically in FIG. 4, in a left portion of the valve arrangement 36. The LPV 38 is configured as a face-sealing poppet valve that acts as a check valve. The LPV 38 comprises a valve member defining a low-pressure poppet (LPP) 42, which is configured to engage a low-pressure valve seat 44 to close the low-pressure port 32 when required, and correspondingly to lift from the low-pressure valve seat 44 to open the low-pressure port 32. The LPP 42 is biased away from the low-pressure valve seat 44 by an LPV return spring 46, and so the LPV 38 is configured as a normally-open valve.

In the arrangement shown in FIG. 4, the LPV 38 is configured to be normally open, and is thus open during intake strokes, primarily under the action of a spring force provided by the LPV return spring 46. During intake stroke flow via the LPV 38, hydrodynamic forces acting on the LPP 42 generally align and compound with the respective spring force. Closing movement of the LPV 38 is controlled by a solenoid actuator, for example. The LPV 38 can therefore be closed selectively, at a variable stage of the working cycle, enabling the volume of fluid admitted to and/or pressurised within the working chamber 28 and displaced through the HPV 40 on each working cycle to be regulated. This, in turn, controls the extent to which the fluid is pressurised, and the quantity of fluid displaced, in each pumping stroke. Accordingly, the output of the PCU 18 is independently controllable from the output of other PCUs, and is controllable on a cycle-by-cycle basis. An LPV 38 can also be controlled such that it remains open to the low-pressure connection on both intake and outlet strokes, to produce inactive cycles of the corresponding PCU 18, so that the PCU 18 effectively idles. This may be useful, for example, when pumping of a PCU or pump module to create high pressure flow via the HPV is desired to cease for a period.

The HPV 40 is shown to the right of the valve arrangement 36 in FIG. 4, and is also configured as a face-sealing poppet valve that acts as a check valve. The HPV 40 therefore comprises a high-pressure valve member defining a high-pressure poppet (HPP) 48. The HPP 48 is configured to engage a high-pressure valve seat 50 to close the high-pressure port 34 when required, and correspondingly to lift from the high-pressure valve seat 50 to open the high-pressure port 34. The HPP 48 is biased into engagement with the high-pressure valve seat 50 by an HPV return spring 52, and so the HPV 40 is configured as a normally-closed valve.

The HPP 48 is on an opposite side of its valve seat 50 to the working chamber 28, and so the HPV 40 is configured to open passively during pumping strokes when the fluid pressure in the working chamber 28 overcomes the opposing force provided both by the spring force of the HPV return spring 50, and the pressure force acting on the other side of the HPP 48 connected to the high-pressure manifold, to allow high-pressure fluid to be discharged. In the example of a motor or pump/motor, the HPV 40 may also be solenoid-actuated to enable the HPV 40 to be opened selectively, to enable the volume of high pressure fluid admitted to the working chamber 28 on each cycle to be regulated.

It is noted that the PCU architecture shown in FIG. 4 is purely illustrative, and other arrangements are possible and may be used in embodiments of the invention.

Returning to FIGS. 1 and 2, each ECP 10 includes fifteen PCUs 18 in total, which as noted above are arranged in three axially-spaced banks 54 of five PCUs 18 each, the PCUs 18 of each bank 54 forming a circular array around, and being in driving engagement with, a respective cam 16 of the associated driveshaft 12. The overall assembly 8 therefore has thirty PCUs 18 in total, arranged in six banks 54 spaced along the shaft axis.

Taking the first ECP 10a as an example, FIGS. 1 and 2 make clear that the PCUs 18 of the upper and lower banks 54 have the same orientations, such that each PCU 18 of the upper bank is circumferentially aligned with a PCU 18 of the lower bank, the respective cylinder axes 20 of the aligned PCUs 18 being at the same angle relative to the shaft axis. Meanwhile, the middle bank 54 is rotated slightly relative to the upper and lower banks 54, such that the PCUs 18 of the middle bank are circumferentially offset from those of the upper and lower banks 54. The respective cylinder axes 20 of the PCUs 18 are therefore angularly spaced around the shaft axis by an angle represented as angle ‘A’ in FIG. 2, which is approximately 24° in this example. Offsetting the middle bank 54 in this way allows the axial spacing between the banks 54 to be reduced and thus promotes a compact configuration.

The PCUs 18 of each ECP 10 are also arranged in groups of three to define triplets, each triplet including one PCU 18 from each bank 54 of the corresponding ECP 10, so that each PCU 18 of a triplet engages a different cam 16 of the associated driveshaft 12.

As FIGS. 1 and 2 reveal, the PCUs 18 of each triplet are arranged at similar circumferential positions with respect to the associated shaft axis, so that the respective high-pressure ports 34 of the PCUs 18 of a triplet form a substantially equilateral triangle, due to the circumferential offset of the PCU 18 of the middle bank 54. Accordingly, the respective piston slippers 22 of the triplet each engage their corresponding cam 16 at similar angular positions relative to the driveshaft 12.

As noted above, the eccentricities of the cams 16 are mutually offset. This offset is configured such that the PCUs 18 of a triplet are phased at 120° intervals. This entails a 120° offset between the upper and lower cams 16, and a slightly different offset for the middle cam 16, specifically 96° in this example, to account for the offset of 24° in the circumferential position of the PCU 18 of the middle bank 54. In this way, the PCUs 18 of a triplet are equiphased.

The PCUs 18 of each triplet are fluidly coupled to define a pump module 56 of the associated ECP 10, so that each ECP 10 has a set of five pump modules 56, one of which is designated by a generally square dashed box in FIG. 1. It follows that the double machine defined by the machine assembly 8 has ten pump modules 56, each providing an independently-operable outlet.

In this respect, the high-pressure ports 32 of the PCUs 18 belonging to a pump module 56 are ganged, in that the fluid displaced by the PCUs 18 is combined. In this example, the PCUs 18 of each pump module 56 displace fluid into a respective common high-pressure manifold, or ‘gallery’ 58. Each gallery 58 is defined by a straight passage formed as a drilling in the housing 14 of the ECP 10, each drilling extending parallel to the shaft axis. Such drillings are advantageously relatively straightforward to manufacture. Each gallery 58 is in fluid communication with the respective high-pressure ports 32 of the associated PCUs 18, and is situated halfway between the cylinder axes 20 of those PCUs 18, extending from an axial position corresponding to the outermost PCU 18 towards the axial centre of the assembly 8.

Accordingly, as FIG. 2 shows best each ECP 10 has a set of five mutually parallel galleries 58 that are equi-angularly spaced around the shaft axis, each handling the output of a respective pump module 56.

In this example, the constituent PCUs 18 of each pump module 56 are configured to operate out-of-phase with each other due to the offset eccentricities of the associated driving cams 16, such that the respective phases are evenly spread over the 360° range of the driveshaft 12. This reduces ripple in the output from the pump module 56 in operation. As also noted above, the PCUs 18 of each bank 54 are also equiphased due to the regular angular spacing of the PCUs 18 around the associated driving cam 16. In consequence, in this example all of the PCUs 18 of each ECP 10 are out-of-phase with one another, and indeed are equiphased.

This equiphased state arises because the angular spacing between the PCUs 18 of each bank 54 is different to the angular spacing between the PCUs 18 of each pump module 56, and neither is a multiple of the other. More specifically, PCUs 18 of a bank 54 are phased at 72° intervals, and PCUs 18 of a pump module are phased at 120° intervals.

This principle can be generalised, in that equiphasing between all PCUs of an ECM having a similar topology to the present example, and between the respective PCUs of each machine module of the ECM, can be achieved if the number of banks of PCUs is coprime with the number of PCUs in each bank, that is, these two values have no common factors other than one. This principle can be extended to the overall assembly 8 defined by the double machine, in that equiphasing is possible for the assembly 8 as a whole since the total number of banks 54 is coprime with the number of PCUs 18 in each bank, which values are six and five respectively in this example. If the machines are identical and so have the same number of banks each, it follows that each bank must have an odd number of PCUs to satisfy this coprime requirement.

The configuration of the assembly 8 to achieve and exploit this equiphasing shall now be considered in more detail.

In this respect, as FIG. 1 shows, the first and second ECPs 10 are coupled end-to-end with reverse orientations, which is evident from the respective orientations of the triangles formed by the triplets of each ECP 10 in FIG. 1. This may be referred to as the ECPs 10 being coupled ‘back-to-back’. Accordingly, the ECPs 10 are not in mirror relation to each other.

The ECPs 10 are coupled with matching circumferential orientations, such that each pump module 56 is circumferentially aligned with a corresponding pump module 56 of the other ECP 10, defining a pair of adjacent pump modules 56. In particular, the respective high-pressure galleries 58 of each pair of pump modules 56 are circumferentially aligned and are thus coaxial. Each pair of aligned galleries 58 are fluidly connected, thereby ganging the associated pump modules 56 to form hexlets comprising three PCUs 18 from each ECP 10.

In this respect, the machine assembly 8 further comprises a ganging block 60 disposed between the first and second ECPs 10, the ganging block 60 being configured to connect each pair of aligned galleries 58, and therefore the associated pump modules 56, to form the hexlets in a selective manner. The ganging block 60 therefore acts as a module connector. The ganging block 60 also defines a pair of outlet ports for the assembly 8.

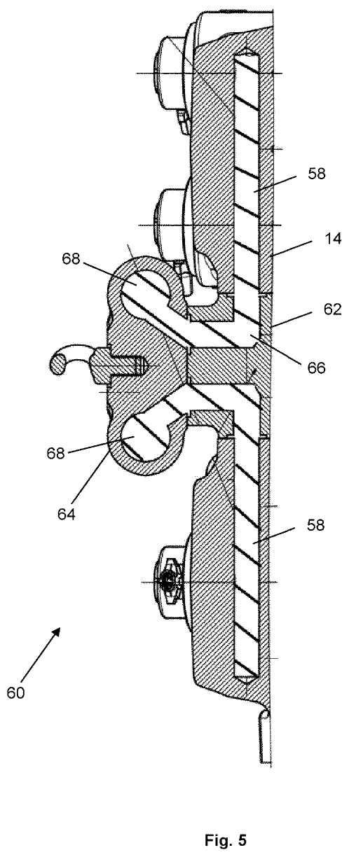

Referring now to FIG. 5, in this example the ganging block 60 is embodied as an assembly that is divided into an intermediate block 62 and a top ganging block 64 that is radially outward of the intermediate ganging block 62. The intermediate ganging block 62 is disposed between the respective housings 14 of the ECPs 10, and includes intermediate passages 66 defining openings that align with corresponding exit openings of each gallery 58. These intermediate passages 66 turn through a right angle to extend radially and connect with corresponding output lines 68 in the top ganging block 64. The output lines 68 can then be connected to one another or to output lines associated with other galleries 58, either selectively or permanently, in any suitable way.

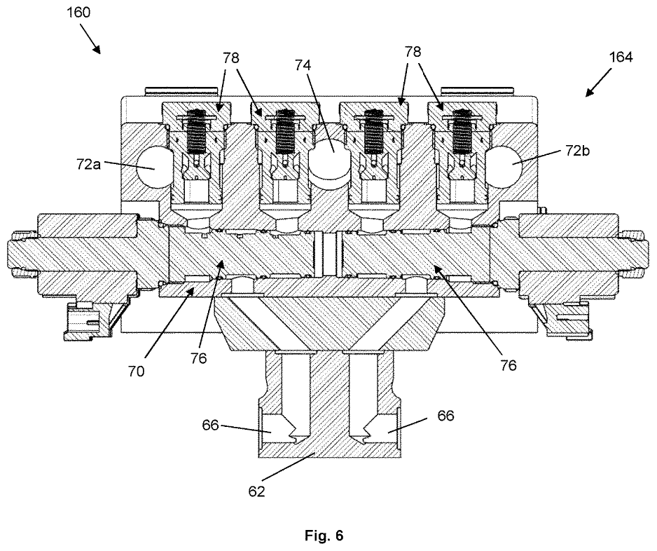

FIG. 6 provides a similar cross sectional view to FIG. 5 of a variant of the ganging block 160, which may also be implemented in the assembly 8 of FIG. 1. The ganging block variant 160 shown in FIG. 6 has the same intermediate ganging block 62 as the variant of FIG. 5, although the portion of the intermediate ganging block 62 including the galleries 58 is hidden in FIG. 6. The top ganging block 164, however, is different to that of FIG. 5.

Specifically, in the FIG. 6 variant 160 the top ganging block 164 includes a valve arrangement 70, the valve arrangement 70 being configured to connect a pair of intermediate passages 66 visible at the bottom of FIG. 6 selectively to either one of a pair of output lines of the ganging block 160, namely a first output line 72 and a second output line 74. In turn, the first output line 72 connects to a first output port (not shown) of the ganging block 160, and the second output line 74 connects to a second output port (not shown) of the ganging block 160, the first and second output ports defining the output ports of the assembly 8.

In the region of the section taken in FIG. 6, the first output line 72 is divided into two branches, namely a first branch 72a shown to the left in FIG. 6 and a second branch 72b shown to the right. The second output line 74 extends between the first and second branches 72a, 72b.

The output lines 72, 74 extend orthogonally to the plane of the cross section in FIG. 6, and so appear as a row of three openings extending across an upper portion of the top ganging block 164 in FIG. 6.

The valve arrangement 70 includes a pair of two-way spool valves 76, each of which is associated with a respective one of the intermediate passages 66. Each spool valve 76 is operable to connect its respective intermediate passage 66 to either one of the output lines 72, 74. The branching of the first output line 72 facilitates this, in that the intermediate passage 66 shown on the left in FIG. 6 can be connected to the first branch 72a, and correspondingly the intermediate passage 66 shown on the right in FIG. 6 can be connected to the second branch 72b. The spool valves 76 may be conventional in construction and so are not shown or described in detail in the interests of clarity.

The valve arrangement 70 further includes a row of four check valves 78, which act to prevent cross flow between the output lines 72, 74 when the spool valves 76 are switching positions. Again, the check valves 78 may be conventional.

Accordingly, the valve arrangement 70 is operable to connect each of the associated intermediate passages 66, and in turn the corresponding pump modules 56, to either one of the output ports of the assembly in a selective manner. It should be appreciated that the ganging block 160 includes a respective valve arrangement 70 for each pair of intermediate passages 66 and the associated pump modules 56 of the assembly 8. Accordingly, the valve arrangements 70 collectively enable any pump module 56 to be fluidly coupled to either one of the output ports of the assembly 8. This creates a wide range of possible operating states for the assembly 8 and thus enhances flexibility in the flow that can be delivered through each output port.

It also follows that the ganging of the pump modules 56 of each hexlet is selective, so that the respective outputs of the pump modules 56 of the hexlet may be separated at times, according to the requirements of the application.

Other configurations for the ganging block are also possible. For example, the intermediate passages 66 or output lines 68 may be in permanent fluid communication, such that the associated galleries 58 and pump modules 56 are permanently ganged as hexlets. More generally, the valve arrangement 70 shown in FIG. 6 is purely an example, and various other ganging arrangements may be used. It is also possible for the ganging block 60, 160 to be omitted, and for ganging of the pump modules 56 to take place externally of the assembly 8.

Returning to the matter of phasing the PCUs 18, as noted above the respective driveshafts 12 of the first and second ECPs 10 are coupled with an angular offset, so that the respective sets of cams 16 of each driveshaft 12 are correspondingly angularly offset and so out-of-phase with one another. More specifically, the cams 16 of the driveshafts 12 are set such that their respective phases, in other words the respective angular orientations of the cams 16, are interleaved and at regular intervals of approximately 60°, accounting for the adjustment of each middle cam 16 due to the circumferential offset of the corresponding PCUs 18 of the middle bank 54 of each ECP 10. Specifically, the cams 16 are offset at 84° intervals in this example, so that the phases of the PCUs 18 are at regular 12° intervals.

The phase of a PCU 18 is dependent on both the angular orientation, or phase, of the cam 16 that drives the PCU 18 and the angular position of the PCU 18 with respect to the cam 16. Accordingly, adjusting the phases of the cams 16 of the second driveshaft relative to the cams 16 of the first driveshaft 12 creates a corresponding adjustment in the phases of the PCUs 18 of both the banks 54 and the pump modules 56 of the second ECP 10b.

In this way, the PCUs 18 of the entire assembly are equiphased, the phases of the respective PCUs 18 of each ECP 10 being interleaved. The phases of the PCUs 18 of each hexlet are also equiphased.

In this example, the shaft offset, or more precisely the angular offset between the cams 16 of each shaft 12, that is required, or can be implemented, to produce equiphased PCUs 18 in this way may be determined according to the following formula:

$${Offset}_{hexlets equispaced} = A + ( \frac{360}{2 {N}_{{PCUs}_{module}}} ) + ( \frac{360}{{N}_{{PCUs}_{module}}} ) ( i - 1 )$$

in which:
A is the angle shown in FIG. 2 between the cylinder axes 20 of PCUs 18 of a pump module 56, which is 24° in this example;
N_{PCUs}_{_{module}} is the number of PCUs 18 ganged by each high-pressure gallery 58, which is three in this example; and
i is any integer between 1 and N_{PCUs}_{_{module}}.

The equation below ensures all PCUs are equispaced.

$${Offset}_{All PCUs Equispaced} = A + ( \frac{360}{2 {N}_{PCUs , total}} ) + ( \frac{2 \times 360}{{N}_{PCUs , total}} ) ( k - 1 )$$

k is any integer between 1 and N_{PCUs,total}
N_{PCUs,total} is all cylinders of both ECPs

So, in the present example the above formula indicates possible offset values of 84°, 204° or 324° between the driveshafts 12 of the first and second ECPs 10 to achieve equiphased PCUs 18 in each hexlet.

It is noted that, in this example, achieving both equiphased PCUs 18 throughout the assembly 8 and equiphased hexlets is enabled by the coprime relationship referred to above between the number of banks 54 and the number of PCUs 18 in each bank 54.

The functionality of the ganging block 60, 160 to gang any two or more pump modules 56 to either one of the output ports of the assembly 8 gives rise to various potential operating modes. In one strategy, pump modules 56 may be ganging and operated in two notional groups that together form a ‘service pumplet’. A first group, which may be referred to as a ‘modulating pumplet’, may comprise a hexlet, while the second group is composed of one or more other pump modules 56 and may be referred to as an ‘offset pumplet’. In operation, the ganging block 60, 160 connects the pump modules 56 of the modulating pumplet and the offset pumplet to one of the output ports of the assembly 8, thereby defining a service pumplet flow.

The characteristics of the service pumplet flow can be regulated by controlling the modulating pumplet and the offset pumplet in different ways to one another, in the sense that each pumplet provides a different flow, whilst ensuring that the combined flow from the modulating and offset pumplets meets the present demand.

For example, the PCUs 18 associated with the offset pumplet may always be active, albeit not necessarily operating at full stroke, while the modulating pumplet is modulated to vary the overall service pumplet flow. In this respect, modulating the modulating pumplet entails operating the LPVs 38 of the associated PCUs 18 to regulate the quantity of fluid that is displaced by each PCU 18 on each cycle. It is noted that each PCU 18 of the modulating pumplet may displace a different quantity of fluid, although it may be preferred for all PCUs 18 of the modulating pumplet to deliver the same flow for a steady output. It is also possible to operate the PCUs 18 of the modulating pumplet in sub groups, for example to control a first group composed of alternate PCUs 18, with respect to the PCU phasing, to deliver a different flow to the remaining PCUs 18 forming a second group, the first and second groups therefore being interleaved.

Varying the service pumplet flow primarily through modulating an equispaced hexlet promotes sustained steady and low ripple flow from the service pumplet while the flow rate alters to meeting changing demands.

It will be appreciated by a person skilled in the art that the invention could be modified to take many alternative forms to that described herein, without departing from the scope of the appended claims.

For example, the ganging block could be implemented in various different ways. In some embodiments, separate ganging blocks are used for each hexlet. It is also possible for ganging to take place in the intermediate ganging block, which may also be integral with the top ganging block.

Instead of separate driveshafts that are coupled together, it is also possible for two machines to share a common driveshaft. In this situation, the common driveshaft includes a respective set of cams for each machine, those sets of cams being mutually offset to achieve the same effect as the separate driveshafts of the above example.

Also, although the above example relates to a hydraulic machine assembly having individual machines that are arranged end-to-end, with coaxial driveshafts, other embodiments of the invention provide hydraulic machine assemblies in which hydraulic machines are arranged side-by-side, with parallel, radially spaced driveshafts. Rotation of the driveshafts may be coupled via a gearbox, for example, such as a splitter gearbox.

Similarly, a pair of machines may be arranged back-to-front or front-to-front, and not back-to-back as in the embodiment described above. In the case of a back-to-front configuration, the machines may exhibit a generally mirror relation to one another. The high-pressure galleries of a hexlet may not be coaxial in such an arrangement, in which case the ganging block can be updated accordingly to accommodate the altered fluid connections.

1. A hydraulic machine assembly, comprising:
a first hydraulic machine comprising a first set of machine modules arranged around a first machine shaft, each machine module of the first set comprising a group of fluidly-coupled piston assemblies in driving engagement with a first set of cams carried by the first machine shaft; and
a second hydraulic machine comprising a second set of machine modules arranged around a second machine shaft, each machine module of the second set comprising a group of fluidly-coupled piston assemblies in driving engagement with a second set of cams carried by the second machine shaft;
wherein rotation of the second machine shaft is coupled to rotation of the first machine shaft;
wherein the first set of cams are angularly offset relative to the second set of cams, and respective angular orientations of the cams of the first set of cams are interleaved with respective angular orientations of the cams of the second set of cams;
and wherein all of the piston assemblies of the machine assembly are out-of-phase with respect to one another, the respective phases of the piston assemblies of the machine assembly being evenly spaced.

2. The assembly of claim 1, wherein the respective phases of the piston assemblies of adjacent machine modules of the first and second machines are evenly spaced.

3. The assembly of claim 1, wherein the piston assemblies of the first and second machines are arranged in axially-spaced rows, the piston assemblies of each row being arranged around, and in driving engagement with, a respective cam.

4. The assembly of claim 3, wherein each row of piston assemblies contains an equal number of piston assemblies.

5. The assembly of claim 4, wherein, for each machine, the number of rows of piston assemblies is coprime with the number of piston assemblies in each row.

6. The assembly of claim 5, wherein the total number of rows of piston assemblies of the machine assembly is coprime with the number of piston assemblies in each row.

7. The assembly of claim 3, wherein each machine module comprises at least one piston assembly from each row of the associated machine.

8. (canceled)

9. The assembly of claim 3, wherein, for each row of piston assemblies, each piston assembly of the row belongs to a different machine module of the associated machine.

10. The assembly of claim 1, comprising a module connector configured to connect machine modules of the first and second machines fluidly, wherein the module connector is optionally configured to connect any two or more machine modules of the assembly fluidly, and wherein the module connector comprises a valve arrangement that is operable to fluidly connect or disconnect machine modules selectively.

11. (canceled)

12. (canceled)

13. (canceled)

14. The assembly of claim 1, wherein adjacent machine modules of the first and second machines are circumferentially aligned with respect to the first and second machine shafts.

15. (canceled)

16. The assembly of claim 1, wherein, for each machine module, the respective phases of the piston assemblies of the machine module are evenly spaced.

17. The assembly of claim 1, wherein the first machine is electronically commutated and the second machine is electronically commutated, and wherein each piston assembly comprises a high-pressure port and a high-pressure valve for controlling flow through the high-pressure port.

18. (canceled)

19. (canceled)

20. (canceled)

21. (canceled)

22. (canceled)

23. The assembly of claim 1, wherein each piston assembly includes a low-pressure port and a low-pressure valve for controlling flow through the low-pressure port, and wherein each piston assembly comprises an actuator for opening and/or closing the low-pressure valve, the actuator being operable to open and/or close the low-pressure valve selectively to regulate the volume of fluid admitted to and/or pressurised within a working chamber of the piston assembly on each working cycle of the piston assembly.

24. (canceled)

25. (canceled)

26. (canceled)

27. The assembly of claim 23, wherein each piston assembly is configured for partial and/or idle working cycles.

28. The assembly of claim 1, wherein each machine module is independently operable.

29. (canceled)

30. The assembly of claim 1, wherein, for each piston assembly, the phase of the piston assembly comprises a phase of a working cycle of the piston assembly.

31. The assembly of claim 30, wherein the working cycles of all of the piston assemblies of the machine assembly are out-of-phase with respect to one another, the respective phases of the working cycles of the piston assemblies of the machine assembly being evenly spaced.

32. A method of operating the assembly of claim 1, the method comprising allocating two or more machine modules to a first group and one or more machine modules to a second group, and controlling each of the first and second groups independently to deliver respective outputs.

33. The method of claim 32, wherein the first group comprises a machine module of the first set and an adjacent machine module of the second set.

34. The method of claim 33, comprising modulating the output of the first group in preference to the second group to meet a change in demand.
